(19) United States
(12) Patent Application Publication
(10) Pub. No.: US 2023/0172111 A1
(43) Pub. Date: Jun. 8, 2023

(54) POLE POWER TOOL AND FOLDABLE POLE ASSEMBLY

(71) Applicant: Nanjing Chervon Industry Co., Ltd., Nanjing (CN)

(72) Inventors: Hanqing Zheng, Nanjing (CN); Xiangqing Fu

(21) Appl. No.: 17/993,465

(22) Filed: Nov. 23, 2022

(30) Foreign Application Priority Data
Dec. 7, 2021 (CN) 202111486890.8

(51) Int. Cl. A01D 75/00; B25F 5/00; A01D 34/416

(52) U.S. Cl. CPC A01D 75/00; A01D 34/416; B25F 5/00; A01D 2101/00

(57) ABSTRACT

A foldable pole assembly includes a connecting pole assembly and a joint mechanism. The connecting pole assembly includes a first connecting pole and a second connecting pole. The joint mechanism connects the first connecting pole to the second connecting pole and includes a locked state and an unlocked state. The joint mechanism includes an operating member including a first state and a second state. When the operating member is in the first state, the joint mechanism is in the locked state, and when the operating member is in the second state, the joint mechanism is in the unlocked state. The operating member is switched between the first state and the second state through a single motion.

### RELATED APPLICATION INFORMATION

This application claims the benefit under 35 U.S.C. §119(a) of Chinese Patent Application No. CN 202111486890.8, filed on Dec. 7, 2021, which application is incorporated herein by reference in its entirety.

### BACKGROUND

Currently, due to usage requirements, some pole-shaped power tools, for example, grass trimmers, are each provided with a relatively long connecting pole. In the related art, the connecting pole may be composed of only one pole. On the one hand, a relatively long pole may cause inconvenience in storage and placement, and on the other hand, only one pole may affect the strength of use due to an excessive length, further affecting the service life of the structure.

### SUMMARY

A foldable pole assembly for a power tool includes a connecting pole assembly and a joint mechanism. The connecting pole assembly is used for supporting the power tool to satisfy a requirement for completing an operation and includes a first connecting pole and a second connecting pole that are movably connected. The joint mechanism connects the first connecting pole to the second connecting pole and includes a locked state and an unlocked state. The first connecting pole and the second connecting pole are fixed when the joint mechanism is in the locked state; and the first connecting pole and the second connecting pole are capable of moving relative to each other when the joint mechanism is in the unlocked state. The joint mechanism includes an operating member. The operating member includes a first state and a second state. When the operating member is in the first state, the joint mechanism is in the locked state, and when the operating member is in the second state, the joint mechanism is in the unlocked state. The operating member is switched between the first state and the second state through a single motion.

In some examples, the joint mechanism further includes a folded state, where when the joint mechanism is in the folded state, the first connecting pole and the second connecting pole are fixed, the first connecting pole extends along a direction of a first straight line, and the second connecting pole extends along a direction of a second straight line, where the second straight line does not coincide with the first straight line.

In some examples, the joint mechanism includes a first joint member and a second joint member that are connected to the first connecting pole and the second connecting pole, respectively, where the first joint member is connected and fixed to the second joint member when the joint mechanism is in the locked state; and the first joint member and the second joint member are capable of moving relative to each other when the joint mechanism is in the unlocked state.

In some examples, the first connecting pole is capable of being folded relative to the second connecting pole when the joint mechanism is in the unlocked state.

In some examples, the operating member includes an operating portion and a driven portion driven by the operating portion to move; and the operating member is connected to the second joint member, the driven portion is movably connected to the first joint member, the driven portion is connected to the first joint member when the operating member is in the first state, and the driven portion is disengaged from the first joint member when the operating member moves to the second state.

In some examples, the first joint member includes an accommodation mechanism used for connecting and accommodating the driven portion and including an accommodation cavity or a connector.

In some examples, the joint mechanism includes a limiting mechanism including a first limiting portion and a second limiting portion that are disposed on the first joint member and the second joint member, respectively, where the first limiting portion and the second limiting portion are connected when the joint mechanism is in the locked state.

A foldable pole assembly is used for a power tool and includes a connecting pole assembly and a joint mechanism. The connecting pole assembly is used for supporting the power tool to satisfy a requirement for completing an operation and includes a first connecting pole and a second connecting pole that are movably connected. The joint mechanism connects the first connecting pole to the second connecting pole and includes a locked state and an unlocked state. The first connecting pole and the second connecting pole are fixed when the joint mechanism is in the locked state; and the first connecting pole and the second connecting pole are capable of moving relative to each other when the joint mechanism is in the unlocked state. The joint mechanism further includes an operating member. The operating member includes a first state and a second state. When the operating member is in the first state, the joint mechanism is in the locked state, and when the operating member is in the second state, the joint mechanism is in the unlocked state. The operating member in the first state reaches the second state after continuously moving along a first direction and the operating member in the second state reaches the first state after continuously moving along a direction opposite to the first direction.

A foldable pole assembly is used for a power tool and includes a connecting pole assembly and a joint mechanism. The connecting pole assembly is used for supporting the power tool to satisfy a requirement for completing an operation and includes a first connecting pole and a second connecting pole that are movably connected. The joint mechanism connects the first connecting pole to the second connecting pole and includes a locked state and an unlocked state. The first connecting pole and the second connecting pole are fixed when the joint mechanism is in the locked state; and the first connecting pole and the second connecting pole are capable of moving relative to each other when the joint mechanism is in the unlocked state. The joint mechanism further includes an operating member and a locking member. When an external force acts on the operating member, the locking member releases the joint mechanism from the locked state; and when the external force leaves the operating member and the first connecting pole is reset to the locked state, the locking member causes the joint mechanism to reach the locked state.

A foldable pole assembly is used for a power tool and includes a connecting pole assembly and a joint mechanism. The connecting pole assembly is used for supporting the power tool to satisfy a requirement for completing an operation and includes a first connecting pole and a second connecting pole that are movably connected. The joint mechanism connects the first connecting pole to the second connecting pole and includes a locked state, an unlocked state, and a positioning state. The first connecting pole and the second connecting pole are fixed when the joint mechanism is in the locked state; the first connecting pole and the second connecting pole are capable of moving relative to each other when the joint mechanism is in the unlocked state; and when the joint mechanism is in the positioning state, the first connecting pole and the second connecting pole are fixed, the first connecting pole extends along a direction of a first straight line, and the second connecting pole extends along a direction of a second straight line, where the second straight line does not coincide with the first straight line.

A power tool includes the preceding foldable pole assembly, a tool head device, and a drive device. The tool head device is connected to an end of the connecting pole assembly and used for completing an operation of the power tool. The drive device is connected to the other end of the connecting pole assembly and used for supplying power to a tool head.

### BRIEF DESCRIPTION OF DRAWINGS

FIG. 1 is a structural view of a pole power tool according to an example of the present application;

FIG. 2 is a structural view of a foldable pole assembly in FIG. 1;

FIG. 3 is a structural view of the foldable pole assembly in FIG. 2 from another perspective;

FIG. 4 is an exploded view of the foldable pole assembly in FIG. 2;

FIG. 5 is a sectional view of the foldable pole assembly in FIG. 2 taken along section A-A with a joint mechanism in a locked state;

FIG. 6 is a sectional view of the foldable pole assembly in FIG. 2 taken along section A-A with a joint mechanism in an unlocked state;

FIG. 7 is a structural view of the foldable pole assembly in FIG. 2 in a folded state;

FIG. 8 is a structural view of a foldable pole assembly according to another example of the present application;

FIG. 9 is a sectional view of the foldable pole assembly in FIG. 8 taken along section B-B;

FIG. 10 is a structural view of a foldable pole assembly according to another example of the present application;

FIG. 11 is a sectional view of the foldable pole assembly in FIG. 10 taken along section C-C; and

FIG. 12 is a structural view of the foldable pole assembly in FIG. 10 in a folded state.

### DETAILED DESCRIPTION

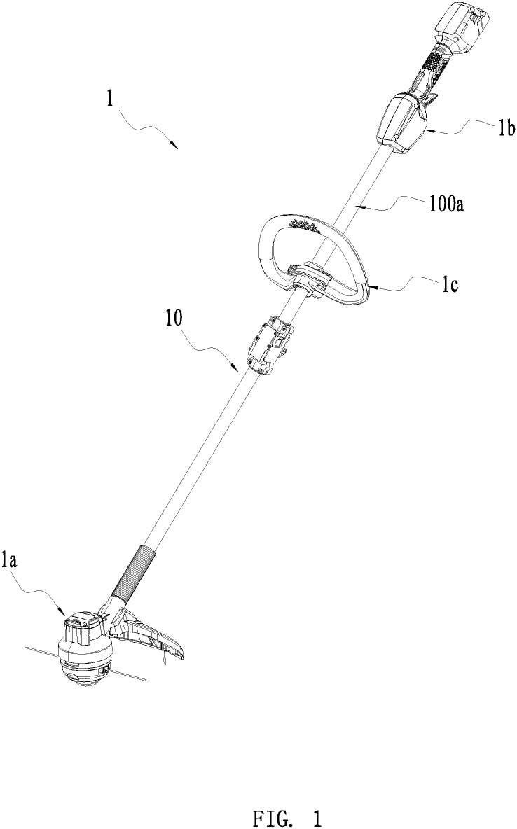

As an example of a power tool, a pole power tool is shown in FIG. 1. The pole power tool is specifically a grass trimmer 1 which may be used for trimming lawns or shrubs. The pole power tool includes a foldable pole assembly 10. This type of pole power tool further includes a tool head device and a power device. The tool head device is connected to an end of the foldable pole assembly 10 and used for performing an operation of the power tool, and the power device is connected to the other end of the foldable pole assembly 10 and used for supplying power to the tool head device. Specifically, using the grass trimmer 1 as an example, a user may operate the grass trimmer 1 to cut grass on a lawn or trim grass around a shrub or a building. The grass trimmer 1 is installed with a grass trimming head body, and the grass trimming head body rotates at a high speed so that the grass is cut.

For the grass trimmer 1, the tool head device is a grass trimming device 1a, the power device may be a main machine device 1b, the foldable pole assembly 10 connects the grass trimming device 1a to the main machine device 1b, and the grass trimmer 1 may further include an auxiliary handle 1c. The grass trimming device 1a is disposed at a first end of the foldable pole assembly 10 and the main machine device 1b is disposed at a second end of the foldable pole assembly 10. The auxiliary handle 1c is disposed on the foldable pole assembly 10 and used for an auxiliary grip of the user. The grass trimming device 1a includes the grass trimming head body and a shield. Preferably, the grass trimming head body includes a grass trimming rope, a grass trimming blade, or the like. The shield surrounds at least part of the grass trimming head body and is used for preventing broken grass clippings or broken stones from splashing onto the user. The grass trimmer 1a further includes an electric motor for driving the grass trimming head body, and the electric motor may be disposed at the grass trimming device 1a at the first end. It is to be understood that the grass trimming device 1a may be considered to include not only the grass trimming head body and the shield but also the electric motor. Alternatively, in other examples, the electric motor may be disposed at the main machine device 1b at the second end of the foldable pole assembly 10. In this case, the main machine device 1b may be considered to include the electric motor. It is to be understood that the grass trimming head body may be installed with the grass trimming rope for mowing, or the grass trimming head body may be installed with a blade for mowing.

The main machine device 1b includes a main handle, a rear housing, and a circuit board assembly disposed in the rear housing. The main handle is held by the user. When the user operates the grass trimmer, the main handle and the auxiliary handle may be held by two hands separately, thereby more stably operating the grass trimmer. Further, the main handle is provided with an operation switch for activating and powering on the grass trimmer 1. After powered on, the grass trimmer 1 can drive the grass trimming head body to rotate at a high speed so as to cut the grass. Further, the rear housing is formed with a coupling portion, the coupling portion is used for being connected to an energy device, the energy device is a battery pack, and the battery pack is used for supplying an electric power source to the grass trimmer. In other examples, the coupling portion may be connected to a cable, and the cable may be connected to a mains electricity grid. In other examples, the coupling portion may be connected to other energy devices. For example, the coupling portion may be connected to a fuel tank, and the fuel in the fuel tank may supply energy to the grass trimmer. The foldable pole assembly 10 connects the grass trimming device 1a and the main machine device 1b into a whole, where the foldable pole assembly 10 has a hollow structure inside so that a connecting line for an electrical connection between the main machine device 1b and a drive device may pass through the hollow structure, which is aesthetically safe.

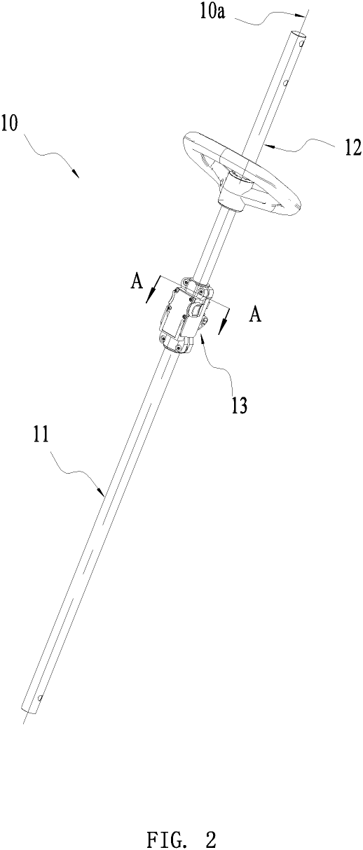

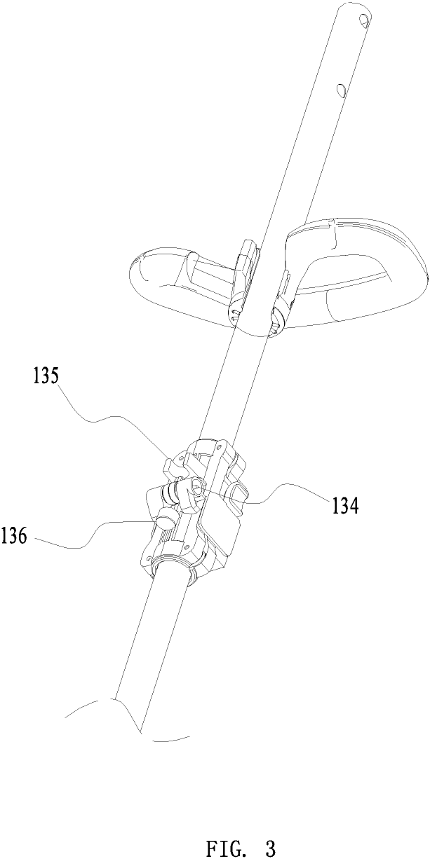

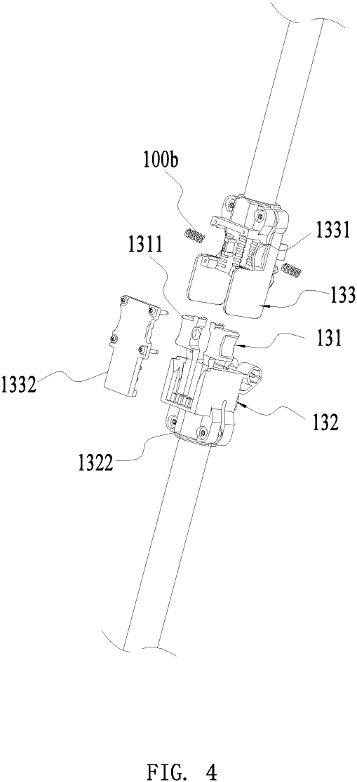

As shown in FIGS. 2 to 5, the foldable pole assembly 10 includes a connecting pole assembly 100a and a joint mechanism 13. The connecting pole assembly 100a is used for supporting the power tool to satisfy a requirement for completing an operation and includes a first connecting pole 11 and a second connecting pole 12 that are movably connected. In this example, the first connecting pole 11 is connected to the tool head device, the second connecting pole 12 is connected to the main machine device, and the joint mechanism 13 is disposed between the first connecting pole 11 and the second connecting pole 12 and connects the first connecting pole 11 to the second connecting pole 12 in such a manner that the first connecting pole 11 and the second connecting pole 12 are movably connected. The first connecting pole 11 and the second connecting pole 12 are arranged with no difference between upper and lower positions and are functionally identical, and the positions of the first connecting pole 11 and the second connecting pole 12 are interchangeable. The first connecting pole 11 and the second connecting pole 12 each have a hollow tubular structure so that a connecting line from the main machine device 1b to the grass trimming device 1a may pass through the hollow tubular structure.

The joint mechanism 13 connects the first connecting pole 11 to the second connecting pole 12 and includes a locked state and an unlocked state. When the joint mechanism 13 is in the locked state, the first connecting pole 11 and the second connecting pole 12 are fixed, and the first connecting pole 11 cannot be folded relative to the second connecting pole 12. When the joint mechanism 13 is in the locked state, the first connecting pole 11 and the second connecting pole 12 extend along the same direction which may be a straight line or a curved line or may be two straight lines or curved lines parallel to each other. In this example, when the joint mechanism 13 is in the locked state, the first connecting pole 11 and the second connecting pole 12 extend along a direction of a first straight line 10a. When the joint mechanism 13 is in the unlocked state, the first connecting pole 11 and the second connecting pole 12 can move relative to each other, and the first connecting pole 11 can be folded relative to the second connecting pole 12. In this example, a relative motion means that the second connecting pole 12 can rotate relative to the first connecting pole 11 and approach the first connecting pole 11. In this example, the relative motion is a folding movement.

The joint mechanism 13 includes an operating member 131, where the operating member 131 includes a first state and a second state. When the operating member 131 is in the first state, the joint mechanism 13 is in the locked state, and when the operating member 131 is in the second state, the joint mechanism 13 is in the unlocked state. The operating member 131 is switched between the first state and the second state through a single motion. The single motion means that the operating member 131 is moved only once from one position to another position along one direction; correspondingly, an operator only needs to perform one operation along one direction. In other words, the operating member 131 in the first state reaches the second state after continuously moving along a first direction 10b and the operating member 131 in the second state reaches the first state after continuously moving along a direction opposite to the first direction 10b. The first direction 10b means that the operating member 131 does not change a direction of movement during state switching and is moved along only one direction, and the first direction may be a direction along a straight line or a direction along a certain curved line, which is not limited here. The continuous motion means that the operating member 131 or part of the structure of the operating member 131 is moved only once from one position to another position, and this motion is continuous. The joint mechanism 13 can be quickly switched between the locked state and the unlocked state and can be quickly and conveniently operated by the user.

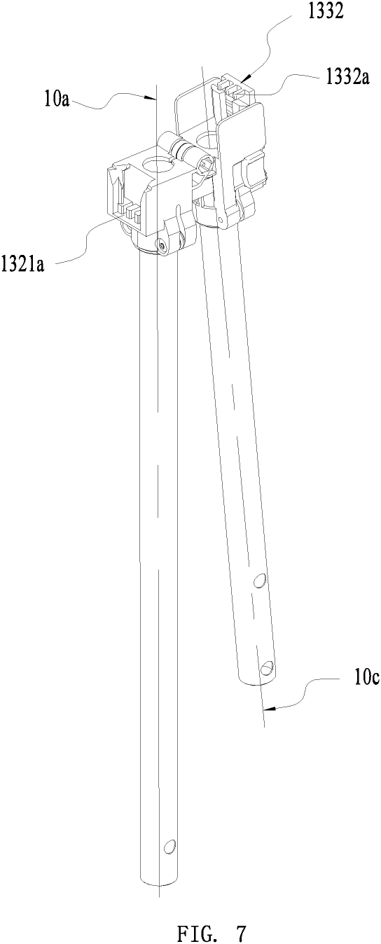

The joint mechanism 13 includes a first joint member 132 and a second joint member 133. The first joint member 132 and the second joint member 133 are connected to the first connecting pole 11 and the second connecting pole 12, respectively. When the joint mechanism 13 is in the locked state, the first joint member 132 is connected and fixed to the second joint member 133. When the joint mechanism 13 is in the unlocked state, the first joint member 132 and the second joint member 133 can move relative to each other so that the first connecting pole 11 can be folded relative to the connecting pole 12. Specifically, the first joint member 132 and the second joint member 133 are connected through a hinge shaft 134. In this case, the first joint member 132 and the second joint member 133 rotate relative to each other about an axis of the hinge shaft 134 so that the first connecting pole 11 and the second connecting pole 12 can rotate relative to the hinge shaft 134 to a folded state shown in the FIG. 7 in the unlocked state. In this example, a direction of the axis of the hinge shaft 134 is perpendicular to the direction of the first straight line 10a.

The operating member 131 includes an operating portion 1311 and a driven portion 1312 driven by the operating portion 1311 to move. The operating member 131 is connected to the second joint member 133 and the driven portion 1312 is movably connected to the first joint member 132. When the operating member 131 is in the first state, the driven portion 1312 is connected to the first joint member 132. When the operating member 131 is moved to the second state, the driven portion 1312 is disengaged from the first joint member 132. Specifically, a reset element 100b is disposed between the operating member 131 and the second joint member 133, where the reset element 100b is specifically a spring. An end of the spring abuts against the operating member 131 and the other end of the spring abuts against the second joint member. Two operating members 131 are provided. When the thumb and the index finger of the user press the two operating members 131 separately, the two operating members 131 move along an extension direction of the spring, that is, the operating members 131 move along the first direction 10b perpendicular to the first straight line. When the thumb and the index finger of the user are disengaged from the operating members 131, the operating members 131 are reset. It is to be understood that the thumb and the index finger of the user press the operating members 131 such that the operating members 131 are moved along the first direction 10b, which is a single motion. In this example, the operating portion 1311 and the driven portion 1312 are integrally formed.

The first joint member 132 includes a housing formed with a driven portion accommodation cavity 1321 and a connecting pole accommodation cavity 1322. The driven portion 1312 is disposed in the driven portion accommodation cavity 1321, an end of the driven portion accommodation cavity 1321 is opened, and the operating portion 1311 protrudes from the opening. The driven portion 1312 is formed with a protruding portion 1312a, the driven portion accommodation cavity 1321 is formed with a recessed portion 1323, and the protruding portion 1312a mates with the recessed portion 1323 so that the driven portion 1312 cannot be disengaged from the driven portion accommodation cavity 1321 of the first joint member 132 in the first state. The first connecting pole 11 is mounted in the connecting pole accommodation cavity 1322.

The second joint member 133 includes a housing formed with an operating portion accommodation cavity 1331 and a connecting pole accommodation cavity. Part of the operating portion 1311 is disposed in the operating portion accommodation cavity 1331, the operating portion accommodation cavity 1331 has an opening, and part of the operating portion 1311 is exposed from the opening for the user to operate. The operating portion 1311 is fixed to the second joint member 133 in the direction of the first straight line 10a, and the operating portion 1311 can move relative to the housing of the second joint member 133 along the first direction 10b. In this example, the operating member 131 includes two assemblies disposed symmetrically about the first straight line 10a so that the first direction 10b is opposite relative to one of the assemblies. In this example, the first direction 10b is perpendicular to the first straight line 10a. The connecting pole accommodation cavity here is the same as the connecting pole accommodation cavity 1322 of the first joint member, and the second connecting pole 12 is mounted in the connecting pole accommodation cavity.

Part of the housing of the second joint member 133 is sleeved on the first joint member 132 such that the driven portion 1312 of the operating member 131 is disposed in the driven portion accommodation cavity 1321 and part of the operating portion 1311 is disposed in the operating portion accommodation cavity 1331. The operating portion 1311 and the driven portion 1312 are connected to each other through a connecting portion that passes over the housing at a position where the second joint member 133 is in contact with the first joint member 132. A guide portion is further provided at an end of the operating portion 1311, and correspondingly, a guide groove is disposed on an inner wall of the operating portion accommodation cavity 1331 and used for guiding the movement of the operating portion 1311.

The second joint member 133 further includes a detachable housing cover 1332 for closing the operating portion accommodation cavity 1331 and the driven portion accommodation cavity 1321 at the same time. When the foldable pole assembly 10 is in the locked state, the housing cover 1332 and an end of the housing of the second joint member 133 are both sleeved on the first joint member 132. As shown in FIG. 7, the joint mechanism 13 includes a limiting mechanism including a first limiting portion and a second limiting portion that are disposed on the first joint member 132 and the second joint member 133, respectively, where the first limiting portion and the second limiting portion are connected when the joint mechanism 13 is in the locked state. In this example, the first limiting portion is a slot 1321a, and the second limiting portion is a latch 1332a. As shown in FIG. 7, the latch 1332a is further disposed at an end of an inner wall of the housing cover 1332, where the latch 1332a extends into the driven portion accommodation cavity 1321 and is disposed below the driven portion 1312. When the joint mechanism 13 is in the locked state, the latch 1332a is disposed in the driven portion accommodation cavity 1321 and connected to the slot 1321a at a corresponding positon in the driven portion accommodation cavity 1321. The latch 1332a and the slot 1321a may assist in locking and improve the stability of connection of the joint mechanism 13 in the locked state.

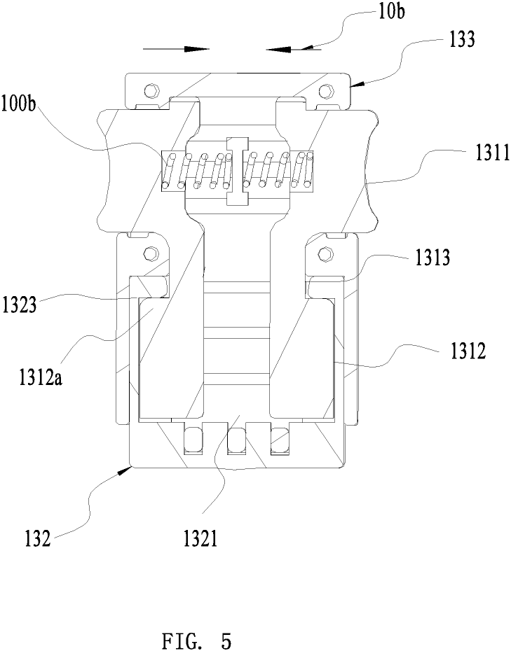

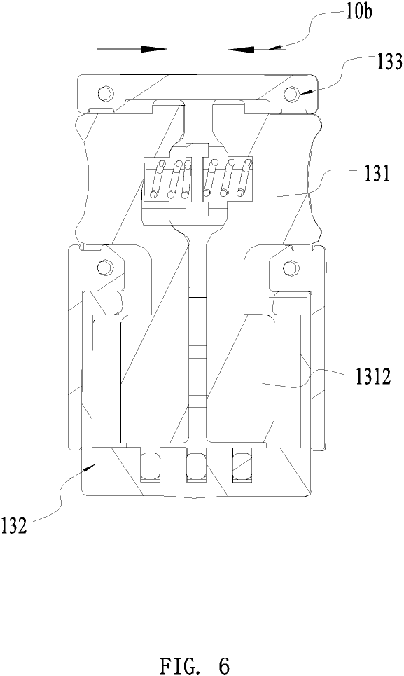

When the joint mechanism 13 is in the locked state, the operating member 131 is at a first position. As shown in FIG. 5, an end of the second joint member 133 and an end of the first joint member 132 are in contact with each other, the driven portion accommodation cavity 1321 communicates with the operating portion accommodation cavity 1331, the operating member 131 passes through the preceding two accommodation cavities, the driven portion 1312 extends into the driven portion accommodation cavity 1321, and the protruding portion 1312a abuts against the recessed portion 1323, thereby locking the first joint member 132 and the second joint member 133, so that that both the first connecting pole 11 and the second connecting pole 12 extend along the direction of the first straight line 10a. As shown in FIG. 6, when the joint mechanism 13 needs to be switched from the locked state to the unlocked state, an external force causes the operating member 131 to slide along the first direction 10b and the operating member 131 moves to a second position. Preferably, the external force generally refers to a thrust of the user. Under the action of the external force, the operating portion 1311 is retracted from the opening and drives the protruding portion 1312a of the driven portion 1312 to be disengaged from the recessed portion 1323 and continuously move to the second position. When the operating member 131 is moved to the second position, the driven portion 1312 may be escaped from the opening of the driven portion accommodation cavity 1321 so that the operating member 131 is disengaged from the first joint member 132, and the end of the second joint member 133 and the end of the first joint member 132 are disengaged, so as to enter the unlocked state. In this manner, the first connecting pole 11 and the second connecting pole 12 can rotate relative to the hinge shaft 134 and be folded.

The joint mechanism 13 further includes a positioning state. As shown in FIG. 7, when the connecting pole assembly 100a is in a folded state, the first connecting pole 11 and the second connecting pole 12 are fixed, the first connecting pole 11 extends along the direction of the first straight line 10a, and the second connecting pole 12 extends along a direction of a second straight line 10c, where the second straight line 10c does not coincide with the first straight line 10a. The slot 1321a and the latch 1332a are disposed on the surface of the housing of the first joint member 132 and the surface of the housing of the second joint member 133, respectively. When the joint mechanism 13 is in the positioning state, the first joint member 132 is connected and fixed to the second joint member 133, and at the same time, the slot 1321a and the latch 1332a are connected. When the operating portion 1311 is disposed on a surface of a first side of the second joint member 133, the slot 1321a and the latch 1332a are disposed on a second side different from the first side, and the connecting pole assembly 100a is folded towards the second side.

Specifically, the slot 1321a should have a slot bottom with a relatively large diameter and a notch with a relatively small diameter so that the latch 1332a is snap-fit more closely. For example, in this example, a shape of the slot 1321a is an arc with a length greater than ½ of a circular arc. In other examples, the slot 1321a may have other shapes such as a stepped shape. Correspondingly, a shape of the latch 1332a is consistent with the shape of the slot 1321a, and in particular, the latch 1332a may form an interference fit with the slot 1321a.

The latch 1332a and the slot 1321a are disposed on the second side of the joint mechanism 13 different from the first side, the hinge shaft 134 is also disposed on the second side, and the latch 1332a and the slot 1321a are symmetrical about the hinge shaft 134 so that as the first joint member 132 and the second joint member 133 rotate nearly to the positioning state, the latch 1332a can be aligned with and connected to the slot 1321a.

In addition to the preceding case where the operating portion 1311 and the driven portion 1312 of the operating member 131 are integrated, in other examples, the joint mechanism may include the operating member and a locking member. When an external force acts on the operating member, the locking member releases the joint mechanism from the locked state; and when the external force leaves the operating member and the first connecting pole is reset to the locked state, the locking member causes the joint mechanism to reach the locked state. The joint mechanism 13 further includes the reset element, where when the joint mechanism 13 is not in the locked state, the reset element can cause the operating member 131 to automatically return from the second position to the first position. The reset element is configured to generate a force for resetting the operating member when the external force applied to the operating member 131 is removed so that when the joint mechanism 13 is changed from the unlocked state to the locked state, the operating member 131 can move from the second position to the first position without an external force. In other examples, the joint mechanism 13 may not include the reset element. Correspondingly, the operating member 131 is made of a deformable material and can generate a reset force itself.

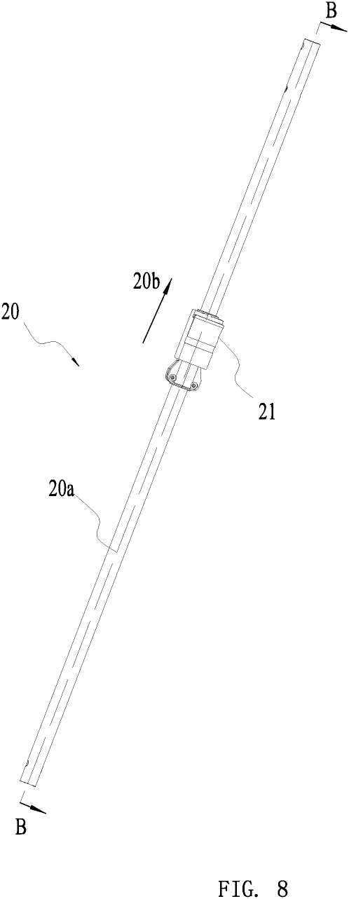

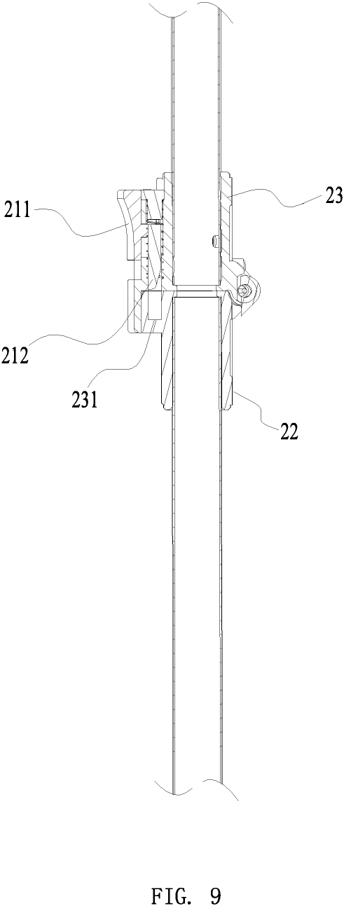

FIGS. 8 and 9 show a foldable pole assembly in another example. The same or corresponding parts of the foldable pole assembly and the foldable pole assembly 10 in FIG. 2 use the corresponding reference numerals. For brevity, this example mainly describes differences between the foldable pole assembly in this example and the foldable pole assembly 10 in FIG. 2.

The joint mechanism includes an operating member 21, where the operating member 21 includes a first state and a second state. When the operating member 21 is in the first state, the joint mechanism is in the locked state, and when the operating member 21 is in the second state, the joint mechanism is in the unlocked state. The operating member 21 is switched between the first state and the second state through a single motion. The single motion means that the operating member 21 is moved only once from one position to another position along one direction; correspondingly, the operator only needs to perform one operation along one direction. In other words, the operating member 21 in the first state reaches the second state after continuously moving along a first direction 20b and the operating member 21 in the second state reaches the first state after continuously moving along a direction opposite to the first direction 20b. The first direction 20b means that the operating member 21 does not change a direction of movement during state switching and is moved along only one direction, and the first direction 20b may be a direction along a straight line or a direction along a certain curved line. The continuous motion means that the operating member 21 or part of the structure of the operating member 21 is moved only once from one position to another position, and this motion is continuous.

In this example, the operating member 21 includes an operating portion 211 and a driven portion 212. The driven portion 212 is driven by the operating portion 211 to move. The operating member 21 is connected to a second joint member 23 and the driven portion 212 is movably connected to a first joint member 22. When the operating member 21 is in the first state, the driven portion 212 is connected to the first joint member 22. When the operating member 21 is moved to the second state, the driven portion 212 is disengaged from the first joint member 22. A connecting groove 231 is formed in a housing of the first joint member 22 and used for being connected to the driven portion 212, and a driven portion accommodation groove is further disposed inside the second joint member 23. When the joint mechanism is in the unlocked state, the driven portion accommodation groove is used for accommodating the retracted driven portion 212. The operating portion 211 is disposed on a surface of the first joint member 22 for the user to operate.

When the joint mechanism is in the locked state, the operating member 21 is at the first position, the end of the second joint member 23 and the end of the first joint member 22 are in contact with each other, the driven portion accommodation groove communicates with the connecting groove 231, and the driven portion 212 passes through the preceding two grooves and is connected to the connecting groove 231, thereby locking the first joint member 22 and the second joint member 23, so that both the first connecting pole and the second connecting pole extend along a direction of a first straight line 20a. When the joint mechanism needs to be switched from the locked state to the unlocked state, an external force causes the operating member 21 to slide along the first direction 20b and the operating member 21 moves to the second position, as shown in FIG. 9. Preferably, the external force generally refers to a thrust of the user. Under the action of the external force, the operating portion 211 moves upwards on a surface of the second joint member 23 to drive the driven portion 212 to be disengaged from the connecting groove 231 and continuously move to the second position. When the operating member 211 is moved to the second position, the driven portion 212 is disengaged from the connecting groove 231 so that the operating member 21 is disengaged from the first joint member 22, and the end of the second joint member 23 and the end of the first joint member 22 are disengaged, so as to enter the unlocked state. In this manner, the first connecting pole and the second connecting pole can rotate relative to the hinge shaft and be folded. In this example, the first direction 20b is parallel to or basically parallel to the first straight line 20a, where being basically parallel means that an included angle between the first direction 20b and the first straight line 20a is not greater than 10° or 15°. In this example, the user holds the operating member 21 or pushes the operating member 21 by hand to slide along the first direction 20b, so as to achieve the state change of the joint mechanism. In this case, the slide of the operating member 21 along the first direction 20b is a single motion.

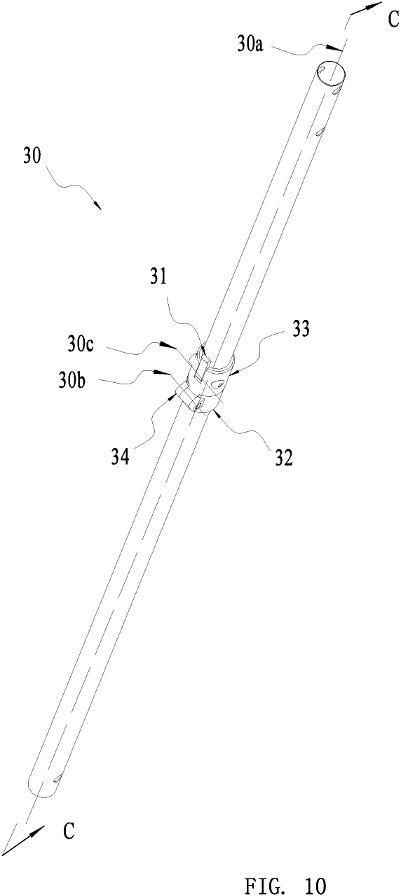

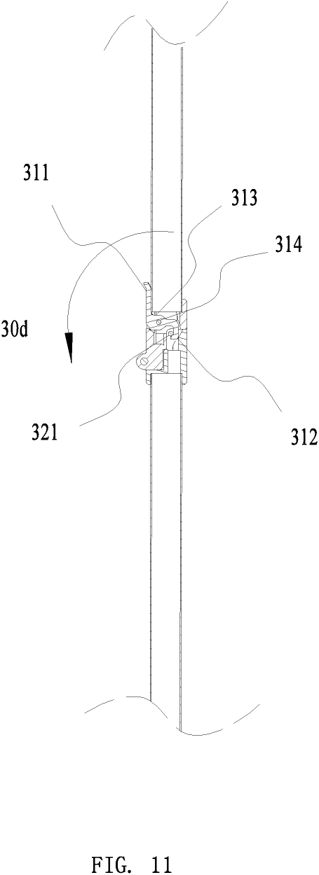

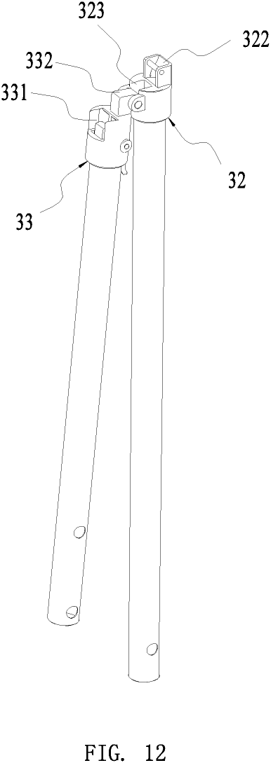

FIGS. 10 to 12 show a foldable pole assembly in another example. The same or corresponding parts of the foldable pole assembly and the foldable pole assembly 10 in FIG. 2 use the corresponding reference numerals. For brevity, this example describes only the differences of this example from example one and example two.

The joint mechanism includes an operating member 31, where the operating member 31 includes a first state and a second state. When the operating member 31 is in the first state, the joint mechanism is in the locked state, and when the operating member 31 is in the second state, the joint mechanism is in the unlocked state. The operating member 31 is switched between the first state and the second state through a single motion. The single motion means that the operating member 31 is moved only once from one position to another position along one direction; correspondingly, the operator only needs to perform one operation along one direction. In other words, the operating member 31 in the first state reaches the second state after continuously moving along a first direction 30d and the operating member 131 in the second state reaches the first state after continuously moving along a direction opposite to the first direction 30b. The first direction 30d means that the operating member 31 does not change a direction of movement during state switching and is moved along only one direction, and the first direction may be a direction along a straight line or a direction along a certain curved line. The continuous motion means that the operating member 31 or part of the structure of the operating member 31 is moved only once from one position to another position, and this motion is continuous.

In this example, the operating member 31 includes an operating portion 311, a driven portion 312, and a connecting portion 313. The driven portion 312 is driven by the operating portion 311 to move. The operating member 31 is disposed on a surface of a housing of a second joint member 33 or on a surface of the second connecting pole, and the driven portion 312 is movably connected to a first joint member 32. When the operating member 31 is in the first state, the driven portion 312 is connected to the first joint member 32. When the operating member 31 is moved to the second state, the driven portion 312 is disengaged from the first joint member 32.

The first joint member 32 includes a housing formed with a first accommodation cavity 322 and a second accommodation cavity 323. A connector 321 for being connected to the driven portion 312 is disposed in the first accommodation cavity 322. Neither the first accommodation cavity 322 nor the second accommodation cavity 323 is closed, and an opening is disposed at an end facing the second joint member 33 and used for connection to a corresponding structure of the second joint member 33.

Specifically, the connector 321 is a rod-like structure fixed within the housing of the first joint member 32, and the corresponding driven portion 312 is a claw-like or hook-like structure connected to the connector 321. In other examples, the connector 321 and the driven portion 312 may be other quick-release structures, which is not limited here.

The second joint member 33 includes a housing formed with a third accommodation cavity 331 and a positioning block 332. At least most of the connecting portion 313 and at least part of the driven portion 312 are disposed in the third accommodation cavity 331, and at least part of the driven portion 312 is disposed in the first accommodation cavity 322 and connected to the connector 321. A fixed shaft 314 is disposed in the second joint member 33, the connecting portion 313 is connected to the fixed shaft 314, and the operating member 31 rotates about a fixed axis 30c of the fixed shaft 314, where a movement direction of the rotation is the first direction 30d.

A hinge shaft 34 is formed at a position where the first joint member 32 and the second joint member 33 are connected. The joint mechanism includes a limiting mechanism including a first limiting portion and a second limiting portion that are disposed on the first joint member and the second joint member, respectively, where the first limiting portion and the second limiting portion are connected when the joint mechanism is in the locked state. In this example, the first limiting portion is the second accommodation cavity 323, and the second limiting portion is the positioning block 332. The positioning block 332 is disposed near the hinge shaft. When the joint mechanism is in the locked state, the positioning block 332 is connected to the second accommodation cavity 323, a shape of the positioning block 332 is consistent with a shape of the second accommodation cavity 323, and after the positioning block 332 is connected to the second accommodation cavity 323, the stability of the connection between the first joint member 32 and the second joint member 33 is further ensured. In this example, a hinge axis 30b of the hinge shaft 34 is parallel to or basically parallel to the fixed axis 30c, where being basically parallel means that an included angle between the first direction 30b and the first straight line 30a is not greater than 10° or 15°. The hinge shaft 34 and the operating portion 311 are disposed on the same side of the joint mechanism, so as to facilitate unlocking and folding operations.

When the joint mechanism is in the locked state, the operating member 31 is at the first position, the end of the second joint member 33 and the end of the first joint member 32 are in contact with each other, the third accommodation cavity 331 communicates with the first accommodation cavity 322, and the driven portion 312 passes through the preceding two accommodation cavities and is connected to the connector 321, thereby locking the first joint member 32 and the second joint member 33, so that both the first connecting pole and the second connecting pole extend along a direction of a first straight line 30a. When the joint mechanism needs to be switched from the locked state to the unlocked state, an external force causes the operating member 31 to rotate along the first direction 30d and the operating member 31 moves to the second position. Preferably, the external force generally refers to a thrust of the user. Under the action of the external force, the operating portion 311 moves away from a surface of the second joint member 33 and drives the driven portion 312 to be disengaged from the connector 321 and continuously move to the second position. When the operating member 31 is moved to the second position, the driven portion 312 is disengaged from the connector 321, and the positioning block 332 is also disengaged from the second accommodation cavity 323 so that the operating member 31 is disengaged from the first joint member 32, and the end of the second joint member 33 and the end of the first joint member 32 are disengaged, so as to enter the unlocked state. In this manner, the first connecting pole and the second connecting pole can rotate relative to the hinge shaft 34 and be folded. In this example, the user toggles the operating member 31 to rotate along the first direction 30d, so as to achieve the state change of the joint mechanism. In this case, the rotation of the operating member 31 along the first direction 30d is a single motion.

The above illustrates and describes basic principles, main features, and advantages of the present application. It is to be understood by those skilled in the art that the preceding examples do not limit the present application in any form, and all technical solutions obtained by means of equivalent substitutions or equivalent transformations fall within the scope of the present application.

What is claimed is:

1. A foldable pole assembly for a pole power tool, comprising:
a connecting pole assembly comprising a first connecting pole and a second connecting pole that are movably connected; and
a joint mechanism connecting the first connecting pole to the second connecting pole;
wherein the first connecting pole and the second connecting pole are fixed when the joint mechanism is in a locked state, the first connecting pole and the second connecting pole are capable of moving relative to each other when the joint mechanism is in an unlocked state, the joint mechanism comprises an operating member, the joint mechanism is in the locked state when the operating member is in a first state, the joint mechanism is in the unlocked state when the operating member is in a second state, and the operating member is switched between the first state and the second state through a single motion.

2. The foldable pole assembly of claim 1, wherein, when the joint mechanism is in a folded state, the first connecting pole and the second connecting pole are fixed, the first connecting pole extends along a direction of a first straight line, and the second connecting pole extends along a direction of a second straight line, and the second straight line does not coincide with the first straight line.

3. The foldable pole assembly of claim 1, wherein the joint mechanism comprises a first joint member and a second joint member that are respectively connected to the first connecting pole and the second connecting pole, the first joint member is connected and fixed to the second joint member when the joint mechanism is in the locked state, and the first joint member and the second joint member are capable of moving relative to each other when the joint mechanism is in the unlocked state.

4. The foldable pole assembly of claim 3, wherein the first connecting pole is capable of being folded relative to the second connecting pole when the joint mechanism is in the unlocked state.

5. The foldable pole assembly of claim 3, wherein the operating member comprises an operating portion and a driven portion driven by the operating portion to move, the operating member is connected to the second joint member, the driven portion is movably connected to the first joint member, the driven portion is connected to the first joint member when the operating member is in the first state, and the driven portion is disengaged from the first joint member when the operating member moves to the second state.

6. The foldable pole assembly of claim 5, wherein the first joint member comprises a connector used for connecting the driven portion.

7. The foldable pole assembly of claim 5, wherein the operating portion and the driven portion are integrally formed.

8. The foldable pole assembly of claim 3, wherein the joint mechanism comprises a limiting mechanism comprising a first limiting portion and a second limiting portion that are disposed on the first joint member and the second joint member, respectively, and the first limiting portion and the second limiting portion are connected when the joint mechanism is in the locked state.

9. The foldable pole assembly of claim 1, wherein the joint mechanism further comprises a reset element driving the operating member to reset.

10. The foldable pole assembly of claim 1, wherein the operating member is switched from the first state to the second state by sliding in only one direction.

11. The foldable pole assembly of claim 1, wherein the operating member is switched from the first state to the second state by rotating in only one direction.

12. A foldable pole assembly for a power tool, comprising:
a connecting pole assembly comprising a first connecting pole and a second connecting pole that are movably connected; and
a joint mechanism connecting the first connecting pole to the second connecting pole;
wherein the first connecting pole and the second connecting pole are fixed when the joint mechanism is in a locked state, the first connecting pole and the second connecting pole are capable of moving relative to each other when the joint mechanism is in an unlocked state, the joint mechanism further comprises an operating member, the joint mechanism is in the locked state when the operating member is in a first state, the joint mechanism is in the unlocked state when the operating member is in a second state, the operating member in the first state reaches the second state after continuously moving along a first direction, and the operating member in the second state reaches the first state after continuously moving along a direction opposite to the first direction.

13. The foldable pole assembly of claim 12, wherein the joint mechanism further comprises a reset element driving the operating member to reset.

14. The foldable pole assembly of claim 12, wherein the operating member is switched from the first state to the second state by sliding in only one direction.

15. The foldable pole assembly of claim 12, wherein the operating member is switched from the first state to the second state by rotating in only one direction.

16. A grass trimmer, comprising:
a grass trimming device for implementing a grass trimming function;
a main machine device for providing power; and
a foldable pole device connecting the grass trimming device to the main machine device;
wherein the foldable pole device comprises a connecting pole assembly comprising a first connecting pole and a second connecting pole that are movably connected and a joint mechanism connecting the first connecting pole to the second connecting pole, the first connecting pole and the second connecting pole are fixed when the joint mechanism is in a locked state, the first connecting pole and the second connecting pole are capable of moving relative to each other when the joint mechanism is in an unlocked state, the joint mechanism comprises an operating member, the joint mechanism is in the locked state when the operating member is in a first state, the joint mechanism is in the unlocked state when the operating member is in a second state, and the operating member is switched between the first state and the second state through a single motion.

17. The grass trimmer of claim 16, wherein the joint mechanism comprises a first joint member and a second joint member that are connected to the first connecting pole and the second connecting pole, respectively, the first joint member is connected and fixed to the second joint member when the joint mechanism is in the locked state, and the first joint member and the second joint member are capable of moving relative to each other when the joint mechanism is in the unlocked state.

18. The grass trimmer of claim 17, wherein the joint mechanism further comprises a reset element driving the operating member to reset.

19. The grass trimmer of claim 17, wherein the operating member is switched from the first state to the second state by sliding in only one direction.

20. The grass trimmer of claim 17, wherein the operating member is switched from the first state to the second state by rotating in only one direction.
